(19) United States
(12) Patent Application Publication
(10) Pub. No.: US 2026/0299159 A1
(43) Pub. Date: Oct. 1, 2026

(54) WELL INTEGRITY EVALUATION WITH EDDY CURRENT DIFFUSION TIME RESPONSE

(71) Applicant: Schlumberger Technology Corporation, Sugar Land, TX (US)

(72) Inventors: Emmanuel Legendre, Clamart (FR); Isabelle Marie Dubourg, Clamart (FR); Fabrice Mege, Clamart (FR); Jean-Luc Le Calvez, Clamart (FR)

(21) Appl. No.: 19/084,898

(22) Filed: Mar. 20, 2025

(51) Int. Cl. G01V 3/28; E21B 47/00; G01V 3/38

(52) U.S. Cl. CPC G01V 3/28; E21B 47/006; G01V 3/38

(57) ABSTRACT

Certain aspects of the present disclosure provide a system for eddy current logging in a well. The system includes one or more transmitter coils in the well configured to generate an excitation current. The system includes one or more receiver coils in the well configured to measure an eddy current response signal, the eddy current response signal comprising a voltage response. The system includes one or more processors configured to determine a frequency-domain transfer function based on a ratio of the voltage response to the excitation current; suppress mutual inductance from the frequency-domain transfer function; and generate a time-domain waveform based on the mutual inductance suppressed frequency-domain transfer function. The system may include a display configured to display information associated with the time-domain waveform.

### BACKGROUND

### Field of the Disclosure

Aspects of the present disclosure relate to well integrity evaluation and, more particularly, to techniques for well integrity evaluation using eddy currents.

### Description of Related Art

In the field of oil and gas exploration, the efficient extraction of hydrocarbon resources is critical for maximizing production and minimizing costs. As geographic locations are increasingly developed for the extraction of hydrocarbons, the proportion of hydrocarbon production coming from mature wells also increases. Therefore, maximizing the productivity and efficiency of existing wells, in turn, becomes increasingly important.

Well intervention is one approach to increasing productivity. At some point in the life of all oil and gas wells, parts will require intervention for maintenance, repair, or replacement. During light interventions, technicians lower tools or sensors into a live well while pressure is contained at the surface. In heavy interventions, the rig crew may stop production at the formation before making major equipment changes.

Well service personnel typically perform light interventions using slickline, wireline, or coiled tubing. These systems allow operators to minimize the possibility of potential well blockages. Operators also order light interventions to change or adjust downhole equipment such as valves or pumps, or to gather downhole pressure, temperature, and flow data. Heavy interventions—also referred to as workovers—may require the rig crew to remove the wellhead and other pressure barriers from the well to allow full access to the wellbore. These operations may require a rig to remove and reinstall the wellhead and completion equipment. Heavy interventions may be used to replace parts such as tubing strings and pumps that cannot be retrieved through light interventions. Some heavy interventions are performed to plug and abandon an original producing zone to reconfigure the well to produce from a secondary zone; these operations are known as recompletions.

Issues like cracks, corrosion, fatigue, pitting, erosion, wear, and defects in components, such as pipes, casing, tubing, coatings, and welds, may arise from a combination of mechanical, chemical, and environmental factors. Repeated pressure cycles, thermal fluctuations, and vibrations can lead to fatigue and cracking, while exposure to corrosive substances (such as water, carbon dioxide, and hydrogen sulfide) and harsh environmental conditions (like saltwater or humidity) leads to corrosion and pitting. High-velocity fluid flows, especially when carrying abrasive particles, cause erosion and wear, manufacturing inconsistencies, or improper application of protective coatings, and can result in variations in material properties and defects in welds.

These issues can pose serious risks, including catastrophic equipment failure that may lead to environmental contamination and significant safety hazards for personnel. If left unchecked, cracks, corrosion, and other defects can escalate rapidly, resulting in unplanned shutdowns, costly repairs, and potentially life-threatening accidents. Regular evaluation and timely repairs are essential to maintain system integrity, ensure regulatory compliance, and protect both human lives and the environment.

Various tests may be conducted to evaluate the well, including logging tools that measure rock properties and fluid sampling. Eddy current testing is a widely used non-destructive evaluation (NDE) method that leverages electromagnetic induction to assess the integrity and material properties of metallic components, such as casing strings, pipelines, tubing, and drilling equipment. Eddy-current analysis uses electromagnetic measurements to detect, characterize, and quantify defects or thinning in metallic casing strings without requiring physical access to each casing layer.

Eddy current testing involves passing an alternating current through a transmitter coil. When an electrical current flows through a coil, a time-varying magnetic field is generated. This magnetic field induces circulating currents—known as eddy currents—in conductive materials (such as metals) near the coil. The induced eddy currents create their own secondary magnetic fields. The behavior of these eddy currents is influenced by the material's electrical conductivity, magnetic permeability, and geometric characteristics (including thickness), thereby providing a sensitive means to detect defects such as cracks, corrosion, and thinning. Changes in the secondary magnetic fields induce a voltage in a receiver coil. Analysis of the voltage response can be performed to determine characteristics of the conductive material under inspection.

One type of eddy current testing is frequency-domain eddy current testing. The system is excited with a continuous sinusoidal signal or a combination of sinusoidal signals (multi-sine or chirp signals) over a broad range of frequencies (e.g., a low frequency selected in a range 1-100 Hz). The transmitter coil generates a harmonic magnetic field that induces azimuthal eddy currents in the test material, and the resulting response is measured by one or more receiver coils. The output signal is then analyzed in the frequency domain, typically by calculating the mutual impedance or the transfer function, which relates the voltage response to the excitation current. The mutual impedance is sensitive to both the electromagnetic properties and the geometric parameters of the pipes. The mutual impedance is complex valued with both amplitude and phase. In practice, a frequency-domain logging tool measures the phase as a phase shift and the amplitude as an attenuation in dB referenced to the values measured in the absence of metal pipes (i.e., the air-calibration measurements of the tool). This approach allows for the detection of anomalies by observing changes in the amplitude and phase of the measured signal at various frequencies, with different frequencies probing different depths of the material.

Time-domain eddy current testing, by contrast, utilizes a pulsed or step excitation to induce eddy currents, capturing the transient response of the system over time. Upon the application of a step current, the induced magnetic field and subsequent eddy currents evolve dynamically, and their decay characteristics are recorded. This transient response contains rich information about the material properties and defect geometry, particularly at later times when the influence of direct coupling has diminished.

Advanced eddy-current tools use multiple frequencies of electromagnetic waves that can penetrate multiple layers of casing. By analyzing the signals, it is possible to differentiate between casings and detect defects in specific layers.

One type of time-domain eddy current testing is pulsed eddy current (PEC), enhancing depth penetration and sensitivity for multiple layers. Rather than measuring the magnetic coupling at selected discrete frequencies between a transmitter coil and several receiver coils located in the far field region, PEC logging tools use a broadband excitation and one or more sensors. Each sensor includes a transmitter coil and a receiver coil which may be mounted on the same core. The transmitter coil is excited by a short, high-energy pulsed excitation (or a step current or square pulsed current) is applied to the transmitter coil, which excites a wide spectrum of frequencies simultaneously. This broadband excitation enables rapid and sensitive probing of the test material, allowing the system to capture both surface and subsurface characteristics within a single pulse. The PEC system records a time-dependent induced voltage response (e.g., transient signal) in the receiver coil and analyzes the response signal to determine information about characteristics and geometry of the conductive material being tested.

Different sensors (i.e., a transmitter coil and receiver coil pair) of different lengths (i.e., different distances between the transmitter coil and receiver coil, e.g., in a range of 1-20 inches) have different penetration depths of investigation measurement. Thus, the use of multiple sensors simultaneously may allow for the inspection of multiple nested pipes in a well.

Both frequency-domain and time-domain eddy current testing techniques have distinct advantages, and the choice between them often depends on the specific requirements of the inspection task. Frequency-domain methods are typically favored for their simplicity and robustness in characterizing steady-state responses, while time-domain methods offer improved sensitivity to transient phenomena and subsurface defects.

One disadvantage of frequency-domain eddy current testing is that the voltage response measurements are usually displayed as wiggles, which are not easily interpretable even qualitatively.

On the other hand, one disadvantage of time-domain eddy current testing is that the voltage response waveform is typically analyzed with respect to a reference waveform, acquired at a point selected among the data and arbitrarily considered as representative of a measurement of a non-corroded portion of the material under inspection. The times at which differences appear in the voltage response waveform with respect to the reference waveform indicate variations in the thickness of the material under inspection.

In the case of a nested pipe configuration (e.g., concentric casings in the well completion), a difference appearing at an early time in the waveform is indicative of a variation of metal in the casings of small diameter (e.g., an inner casing of the nested casing configuration) and a difference appearing at a later time in the waveform is indicative of a variation of a pipe of larger diameter (e.g., an outer casing of the nested casing configuration). Further, a positive variation of the voltage response waveform indicates a slower decay as compared to the reference waveform, corresponding to an increase of metal thickness. A negative variation of the voltage response waveform indicates a faster decay as compared to the reference waveform, corresponding to a decrease in the thickness (i.e., metal loss). However, when thickness variations occur simultaneously on the different nested pipes, the individual thicknesses cannot be correctly identified because the time signature on the response waveforms will overlap.

Therefore, time-domain eddy current testing relies on fragile and user-dependent relative measurements and, in some cases, cannot be used for identifying corrosion in nested pipe configurations.

In addition, the coupling between the transmitter coil and the receiver coil(s) consists of both direct and indirect components. Indirect coupling involves the interaction of the transmitter coil's magnetic field with the material under inspection. Direct coupling occurs between the transmitter coil and the receiver coil(s) without involving the test material. The direct coupling may be due to incorrect positioning of the sensor with respect to the test material. The direct coupling is primarily inductive and can become dominant when the physical spacing between the transmitter coil and the receiver coil(s) is short, potentially overwhelming the useful signal. For example, when the transmitter coil is energized with an excitation current, the transmitter coil immediately generates the strong magnetic field which can induce voltage in the receiver coil does this before significant eddy currents have formed in the test material. Thus, the early-time response of the system is primarily dominated by the direct coupling. The eddy currents take time to diffuse, interact with the tested material's properties, and generate the secondary magnetic fields. Thus, the late-time response of the system may be primarily dominated by the indirect coupling, and is more useful for characterization of the material and the geometry of the material.

Accordingly, only the later portions of the signal (e.g., the late times of the voltage response waveform) may be used because the earlier portions of the signal (e.g., the early times of the waveform) may be dominated by the direct sensor coupling and parasitic effects (e.g., due to sensor misalignment) which are mainly inductive and not affected by conductivity losses in the tested metal. Therefore, it is desirable to remove the direct coupling from the voltage response waveform data so that earlier portions of the signal may be useful.

Accordingly, what is needed is techniques and apparatus for improved eddy-current testing.

### SUMMARY

Certain aspects of the present disclosure provide a system for eddy current logging in a well. The system includes one or more transmitters coil in the well configured to generate an excitation current. The system includes one or more receiver coils in the well configured to measure an eddy current response signal, the eddy current response signal comprising a voltage response. The system includes one or more processors configured to determine a frequency-domain transfer function based on a ratio of the voltage response to the excitation current, suppress mutual inductance from the frequency-domain transfer function, and generate a time-domain waveform based on the mutual inductance suppressed frequency-domain transfer function. The system may include a display configured to display information associated with the time-domain waveform.

Certain aspects provide a method for well integrity evaluation. The method includes generating, via one or more transmitter coils in the well, an excitation current. The method includes measuring, via one or more receiver coils in the well, an eddy current response signal. The eddy current response signal comprises a voltage response. The method includes determining, via one or more processors, a frequency-domain transfer function based on a ratio of the voltage response to the excitation current. The method includes suppressing, via the one or more processors, mutual inductance from the frequency-domain transfer function. The method includes generating, via the one or more processors, a time-domain waveform based on the mutual inductance suppressed frequency-domain transfer function. The method may include displaying information associated with the time-domain waveform. The method includes estimating one or more parameters of a material under inspection based on the time-domain waveform. The method includes evaluating integrity of the well based on the estimated one or more parameters of the material under inspection. The method may include, based on the evaluation of the integrity of the well, at least one of: initiating inspection or repairs of one or more components of the well; or adjusting one or more drilling parameters of the well.

Certain aspects provide a non-transitory computer readable medium comprising computer executable code for eddy current logging in a well.

The computer executable code includes code for determining a frequency-domain transfer function based on a ratio of an eddy current voltage response signal to an excitation current. The computer executable code includes code for suppressing mutual inductance from the frequency-domain transfer function. The computer executable code includes code for generating a time-domain waveform based on the mutual inductance suppressed frequency-domain transfer function. The computer executable code includes code for outputting information associated with the time-domain waveform.

Other aspects provide: an apparatus operable, configured, or otherwise adapted to perform any one or more of the aforementioned methods and/or those described elsewhere herein; a non-transitory, computer-readable media comprising instructions that, when executed (e.g., directly, indirectly, after pre-processing, without pre-processing) by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting the scope of this disclosure.

FIG. 1 depicts an example cased hole for wireless intervention, according to certain aspects.

FIG. 2 depicts an example magnitude Bode plot of the frequency-domain transfer functions of three ferromagnetic pipes, according to certain aspects.

FIG. 3 depicts an example phase Bode plot of the frequency-domain transfer functions of FIG. 2, according to certain aspects.

FIG. 4 depicts an example time-domain representation of the transfer functions of FIG. 2, according to certain aspects.

FIG. 5 depicts an example nested pipe configuration, according to certain aspects.

FIGS. 6A-6B illustrate an example display of time-domain eddy current data for a single casing at various transmitter-receiver spacings, according to one or more aspects.

FIGS. 7A-7B illustrate an example display of time-domain eddy current data for three nested casing at various transmitter-receiver spacings, according to one or more aspects.

FIG. 8 illustrates an example method for well integrity evaluation with eddy currents, according to certain aspects.

FIG. 9 illustrates an example system for well integrity evaluation with eddy currents, according to certain aspects.

### DETAILED DESCRIPTION

Aspects of the present disclosure provide apparatuses, methods, systems, and computer-readable mediums for well integrity evaluation with eddy current testing and analysis.

In some aspects, techniques are provided for acquiring eddy current response signals, determining a frequency-domain transfer function of the eddy current response, and determining a time-domain waveform from the frequency-domain transfer function. In some aspects, direct coupling is suppressed (e.g., removed) from the response signal in determining the time-domain waveform. In some aspects, the time-domain waveform is determined based on a product of time and a step response, the step response being the time-domain response of the system to a step excitation. In some aspects, the time-domain waveform shape is unchanged in response to changing electrical conductivity of the test material.

In some aspects, techniques are provided for displaying the eddy current response data that can be easily interpreted by an operator to detect corrosion (e.g., changes in thickness) in pipes. In some aspects, the operator can detect a depth of the corrosion and further can distinguish the particular corroded pipe in a nested pipe configuration. In some aspects, the eddy current response data is displayed based on an image with a color or intensity of the eddy current response as a function of the depth and the time index, and can further be displayed for multiple different receivers. In some aspects, the identification of the change in thickness and the depth of the change can be determined based on detecting a shift in the time-domain waveform to earlier time indices and/or based on detecting an increase in the peak of the time-domain waveform. In some aspects, the particular corroded pipe from the nested pipe configuration can be identified further based on the time at which the shift or increase occurs and/or based on a comparison of the shift or increase across multiple receivers. In some aspects, early parts of the eddy current response are used for the well integrity evaluation, in addition to the later parts of the response signal.

In some aspects, the improved eddy current testing may be used to improve estimation of the parameters or characteristics of the test material and to improve well integrity evaluation. Improving the well integrity evaluation may help to more accurately or more quickly spot issues in the well such that the issue can be corrected to prevent risks, maintain system integrity, ensure regulatory compliance, and protect both human lives and the environment.

### Example Drilling System

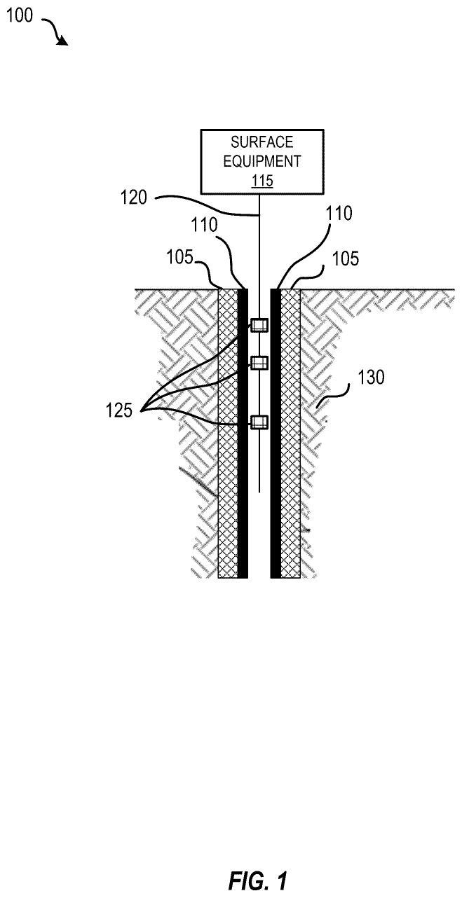

FIG. 1 depicts an example cased hole well 100 in which eddy current testing and analysis may be performed according to certain aspects. It should be understood that FIG. 1 merely depicts an example well, and that the eddy current testing and analysis techniques described herein may be performed for detection in any system.

Cased hole wells are commonly utilized in hydrocarbon extraction to enhance wellbore stability, prevent formation collapse, and improve production control. As shown, the well 100 may be drilled to a predetermined depth into a subterranean formation 130, followed by the insertion of casing 110 to isolate the formation 130 and facilitate fluid extraction. The casing string may be composed of high-strength steel or composite material. The casing 110 may be segmented into multiple sections, including surface casing, intermediate casing, and production casing, each tailored to specific depth and pressure conditions.

A cement slurry 105 may be pumped into an annulus between the formation 130 walls of the wellbore 100 and the casing 110 to secure the casing 110 in place and prevent fluid migration. The cementing process may be optimized to provide zonal isolation, enhance casing integrity, and minimize formation damage.

After cementing, a perforation system may be deployed within the casing 110 to establish communication between the wellbore 100 and the hydrocarbon-bearing formation 130. The perforation system may include shaped charges, jet perforators, or laser-based perforation tools. The perforations may be strategically placed to maximize reservoir exposure while minimizing damage to the casing and surrounding formation.

Following perforation, production tubing (not shown) may be installed to facilitate fluid extraction. The production tubing may be equipped with flow control devices, sand screens, or intelligent monitoring systems to regulate production and optimize recovery. Well stimulation techniques such as acidizing or hydraulic fracturing may be employed to enhance permeability and hydrocarbon flow.

Downhole sensors 125 and real-time monitoring equipment are integrated into the well system to assess pressure, temperature, and flow dynamics. Data analytics and machine learning algorithms can be applied to optimize production rates and predict maintenance requirements.

Wireline intervention involves deployment of tools and instruments, such as the downhole sensors 125, into the cased hole well 100 using a cable or slickline 120 to perform maintenance, logging, or remedial operations. Wireline equipment may include a cable drum, a surface control unit (e.g., surface equipment 115), and specialized downhole tools designed for various applications. Logging tools may be used to assess well integrity, measure pressure and temperature, and evaluate fluid composition.

According to certain aspects, the wireline intervention may include equipment for eddy current testing and analysis as described herein.

Example Well Integrity Evaluation with Eddy Current Testing

Eddy current testing and analysis can be used to estimate characteristics of a material under inspection, which may be useful for evaluating well integrity.

An eddy current system or tool excites a transmitter coil with an electromagnetic signal, referred to herein as the excitation signal or excitation current. The excitation signal may excite a range of frequencies. A frequency-domain based eddy current tool may use a sinusoidal (e.g., multi-sine or chirp) excitation signal. A time-domain based eddy current tool may use a pulsed current or step current excitation signal that excites a broadband spectrum of frequencies simultaneously.

The excitation signal induces a time-varying magnetic field. This magnetic field penetrates through conductive materials and induces eddy currents in the material under inspection. The eddy currents decay over time, with the decay rate depending on material properties such as the thickness, conductivity, and magnetic permeability of the material.

The eddy currents generate secondary magnetic fields. Changes in the secondary magnetic fields induce a voltage response that is measured by the receiver coils. The voltage response signal measured by the receiver coils is referred to herein as the eddy current response signal. In frequency-domain based eddy current approaches, the eddy current response signal may be analyzed in the frequency domain. In the time-domain based eddy current approaches, the time-dependent transient voltage response is analyzed. From Faraday's Law of Induction, the magnetic vector potential will drive a voltage on the receiving coil ends through a magnetic flux variation given by the quasi-stationary eddy current equation:

$${v}_{{Γ}_{RX}} ( t ) = {∮}_{{Γ}_{RX}} E \cdot dl = - \frac{\partial }{\partial {t}_{t}} {∮}_{{Γ}_{RX}} A \cdot dl \qquad ( Eq . 1 )$$

where, E is the electric field around the receiver, v_{Γ}_{_{TX}}(t) is the voltage induced across the terminals of the receiver coil Γ_{RX}, φ_{T}_{_{RX}} E·dl is the line integral of the electric field around the receiver coil, and

$$- \frac{\partial }{\partial {t}_{t}} {∮}_{{Γ}_{RX}} A \cdot dl$$

is the time derivative of the loop integral of the magnetic vector potential reflecting that the voltage is induced by the changes in the magnetic field A.

In some aspects, a double-function coil is used, acting as both the transmitter coil (e.g., driver) and the receiver coil (e.g., pick-up). In some aspects, separate transmitter coil and receiver coils are used.

The induced voltage in the receiver coil depends on the strength of the eddy currents, which is influenced by material properties like thickness, conductivity, and defects. For example, ferromagnetic material introduces magnetic reluctance, which impacts the inductive coupling and eddy currents. Changes in thickness or permeability of the test material will influence the amount of energy coupled into the material, as well as how much energy is reflected back to the receiver coil.

Thus, the eddy current response signal may be analyzed (e.g., using digital signal processing) to determine characteristics of the test material. In some aspects, the analysis of the eddy current response involves calculating the transfer function, which relates the voltage response to the excitation current. The transfer function represents the relationship of the input, i.e., the signal generated by the transmitter coil, and the output, i.e., the eddy current response signal detected by the receiver coil.

The transfer function is the response of the system in the frequency domain and may be converted to the time-domain using a Laplace transform or a Fourier transform. While aspects of the present disclosure are described in the Laplace domain, it should be understood that the aspects equally apply in the Fourier domain.

The characteristics of the test material are not expected change over short periods of time and, therefore, the system may be considered linear-time invariant. In a linear-time invariant system, the transfer function is characterized by the trans-impedance given by the Laplace transform of the continuous-time input excitation signal current i_{Γ}_{_{TX}}(t) to the transmitter coil Γ_{TX} and the Laplace transform of the output eddy current response signal voltage v_{Γ}_{_{RX}}(t) on the receiver coil Γ_{RX}:

$$ℒ \{ {i}_{{Γ}_{TX}} ( t ) \} = {I}_{{Γ}_{TX}} ( s ) ; ℒ \{ {v}_{{Γ}_{RX}} ( t ) \} = {V}_{{Γ}_{RX}} ( s ) ; s = j \cdot ω ; \\ Z ( s ) = \frac{{v}_{{Γ}_{RX}} ( s )}{{I}_{{Γ}_{TX}} ( s )} \qquad ( Eq . 2 )$$

where, Z(s) is the trans-impedance function, s is a complex variable with an imaginary part j·ω representing an oscillatory component.

The mutual impedance is sensitive to both the electromagnetic properties and the geometric parameters of the material under inspection. The mutual impedance is complex valued with both amplitude and phase.

In some aspects, the eddy current tool measures the phase as a phase shift and the amplitude as an attenuation in dB, for example, with respect to values measured in the absence of the material under inspection (e.g., air-calibration measurements of the tool).

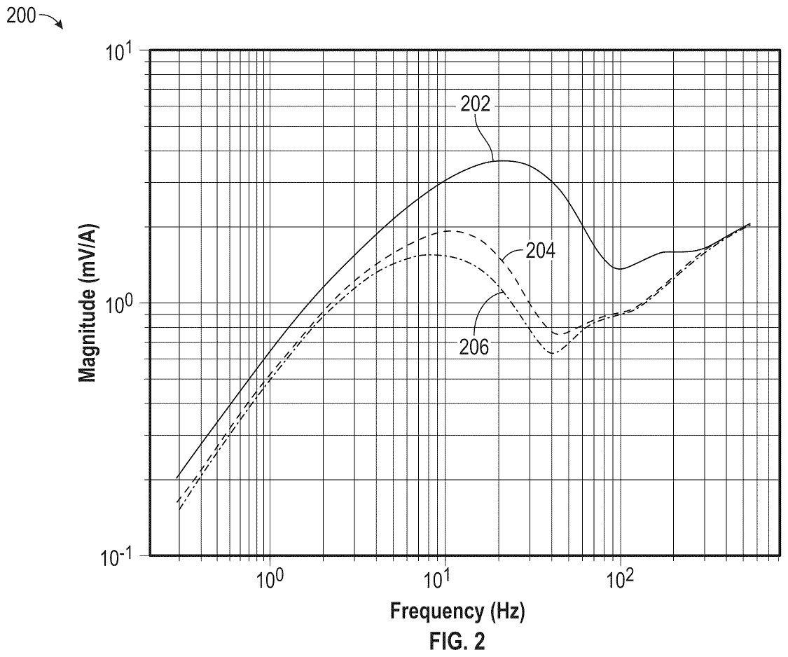

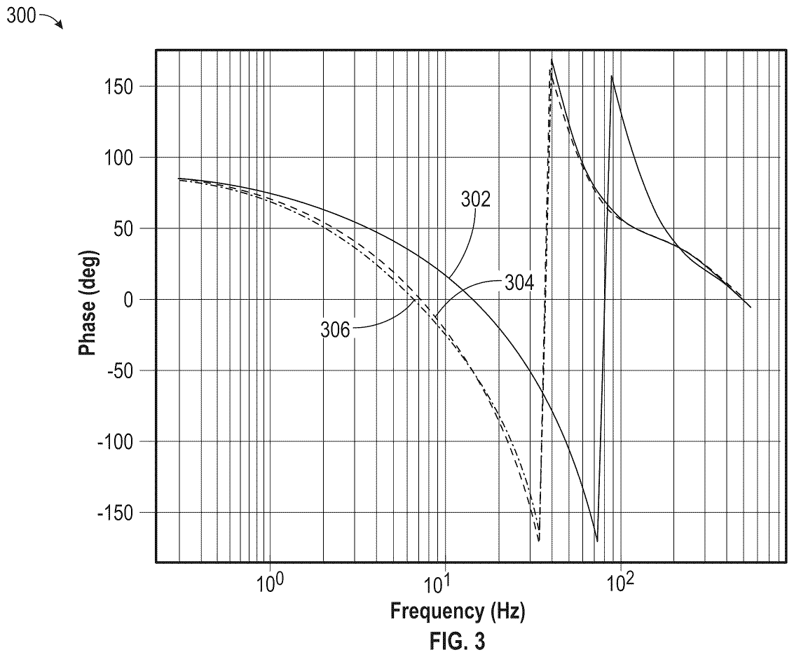

The transfer function can be depicted as a Bode plot. FIG. 2 depicts an example magnitude Bode plot 200 of the frequency-domain transfer functions 202, 204, 206 of three ferromagnetic pipes. The magnitude Bode plot 200 illustrates how the magnitude of the induced voltage changes with the frequency of the excitation signal. The magnitude Bode plot 200 may reflect the influence of material properties like thickness and permeability on inductive coupling and eddy currents. FIG. 3 depicts an example frequency-domain phase Bode plot 300 of the transfer functions 302, 304, 306 of the three ferromagnetic pipes. The phase Bode plot 300 shows the phase shift between the input excitation signal and the output eddy current response signal. The phase shift may change from inductive behavior (positive phase shift) to resistive behavior (negative phase shift) as the excitation frequency increases.

As shown in the Bode plots 200, 300, the system behaves inductively at low frequencies, with the transfer function exhibiting high gain (amplitude) and a phase shift toward +90°. The low frequency part of the transfer function is approximately proportional to the excitation frequency, for example capturing a magneto-static coupling sensitive to magnetic permeabilities and geometries of the casings. As the excitation frequency increases, conductivities of the casings start to play a role. The magnitude decreases due to ohmic losses of the eddy current, with the rate of attenuation varying based on the material's permeability and thickness. The phase would shift towards −90° as the system behaves more resistively due to eddy current formation. At high frequencies, direct couplings and simple reflection on inner-most surface dominate the measurement.

Example Well Integrity Evaluation with Eddy Current Diffusion Time Response

As discussed herein, the transfer function incorporates the effects of inductive coupling, eddy current formation, and how the material's properties (thickness, permeability) affect the interaction. Thus, the eddy current response signal may be analyzed at different time intervals to differentiate between material layers and to detect defects or corrosion in underlying layers. Changes in amplitude of the voltage of the eddy current response signal can indicate material loss (corrosion, thinning) or variations in conductivity (due to alloy composition or temperature effects). A faster rate of decay indicates higher conductivity (since eddy currents dissipate quickly), while a slower rate of decay suggests lower conductivity or thicker material. Changes in impedance may be used to assess properties of the material under inspection

However, as further discussed herein, the early-time response of the system is primarily dominated by the direct coupling, whereas the late-time response of the system may be primarily dominated by the indirect coupling, and is more useful for characterization of the test material. Aspects of the present disclosure provide techniques for removing the direct coupling from the response signal, providing an output waveform that is free of the disturbance of inductive direct coupling and, in addition, having a shape that is independent of the electrical conductivity of the material under inspection.

For the quasi-stationary eddy current approximation, the solution of the eddy current problem satisfies the diffusion equation which models how the eddy current diffuse over time due to the electrical conductivity of the test material:

$$( curl \frac{1}{μ} curl A ( x , t ) ) + σ {\partial }_{t} A ( x , t ) = J ( x , t ) in Ω \times ( 0 , T ) , \\ Ω ⊂ {R}^{3} , and T > 0 \qquad ( Eq . 3 )$$

where, A(x,t) is the magnetic vector potential as a function of space and time, μ is the magnetic permeability of the test material, σ is the electrical conductivity of the test material, J(x,t) is the excitation signal divergence-free current density as a function of space and time, Ω⊂R³ represents the spatial domain, and T>0 defined the time domain of interest. The magnetic vector potential A may be known via a Coulomb gauge.

The current density of the excitation signal is given by:

$$J ( x , t ) = {i}_{TX} ( t ) \times {β}_{TX} ( t ) \times {τ}_{{Γ}_{TX}} ( t ) \qquad ( Eq . 4 )$$

where, J(x,t) is the current density, i_{TX}(t) is the excitation current via a multi-turn coil carrying the current, along a path of the transmitter coil Γ_{TX}, τ_{Γ}_{_{TX}} is the normalized tangential vector along Γ_{TX}, and β_{TX} is a coordinate dependent scalar (e.g., a spatial distribution function) of dimension 1/m² that characterizes the winding density per unit area of the coil.

The transfer function can be decomposed into two contributions:

$$Z ( s ) = M \cdot s + F ( s ) \qquad ( Eq . 5 )$$

where, M is the mutual inductance between transmitter and receiver coils, M·S represents the direct coupling component, and F(s) is the through-sample transfer function change representing the indirect coupling component.

According to certain aspects, the transfer function can be divided by s, followed by a derivation with respect to s, to suppress the mutual impedance (i.e., the direct coupling) component, resulting in:

$$H ( s ) = - \frac{\partial }{\partial s} \frac{Z ( s )}{s} = - \frac{\partial }{\partial s} \frac{F ( s )}{s} \qquad ( Eq . 6 )$$

H(s) is the Laplace transform of a time-domain function waveform h(t). For example, the Laplace transform of the Heavyside step function H(t) is:

$$ℒ \{ H ( t ) \} = \frac{1}{s} \qquad ( Eq . 7 )$$

where, H(t)=0 for t<0 and H(t)=1 for t≥0.

Multiplying a function ƒ(t) in the time domain by t corresponds to the negative derivative of its Laplace transform with respect to s:

$$ℒ \{ tf ( t ) \} = - \frac{\partial }{\partial s} ℒ \{ f ( t ) \} \qquad ( Eq . 8 )$$

Thus, mapping H(s) in the time-domain via an inverse Laplace transform provides the time-domain waveform h(t), and corresponding to the step response multiplied by time t:

$$h ( t ) = t \cdot {ℒ}^{- 1} ( \frac{Z ( s )}{s} ) \qquad ( Eq . 9 )$$

The generated time-domain waveform h(t) is immune to the inductive contribution (M·s) contained in the decomposition of Z(s). As shown in Eq. 6, by suppressing the mutual inductance, H(s) depends only on the through-sample transfer function change F and not on the mutual inductance M.

Also, using this approach, the generated time-domain response waveform h(t) has a shape that is unchanging in response to a change in the electrical conductivity σ of the material. For example, for \tilde{σ}=ασ where α>0, the corresponding magnetic vector potential Ã(x,t) solution of the quasi-stationary eddy current Eq. 3 becomes:

$$( curl \frac{1}{μ} curl \tilde{A} ( x , t ) ) + ασ {\partial }_{t} \tilde{A} ( x , t ) = \tilde{J} ( x , t ) in Ω \times ( 0 , T ) , \\ Ω ⊆ {R}^{3} , T > 0 \qquad ( Eq . 10 )$$

The solution of the quasi-stationary eddy current Eq. 10 is valid for all t∈(0,T) and, therefore, is also valid for all τ=t/α in (0,T/α):

$$( curl \frac{1}{μ} curl \tilde{A} ( x , τ ) ) + ασ {\partial }_{t} \tilde{A} ( x , τ ) = \tilde{J} ( x , τ ) in Ω \times ( 0 , \frac{T}{α} ) , \\ Ω ⊆ {R}^{3} , T > 0 , α > 0 \qquad ( Eq . 11 )$$

Given ∂ₜτ=1/α, the quasi-stationary eddy current solution becomes:

$$( curl \frac{1}{μ} curl \tilde{A} ( x , τ ) ) + σ {\partial }_{t} \tilde{A} ( x , τ ) = \tilde{J} ( x , τ ) in Ω \times ( 0 , \frac{T}{α} ) , \\ Ω ⊆ {R}^{3} , T > 0 , α > 0 \qquad ( Eq . 12 )$$

The Eq. 12 is a time-scaled version of the quasi-stationary eddy current solution for the time interval

$$( 0 , \frac{T}{α} ) ,$$

hence the magnetic vector potential is:

$$\tilde{A} ( x , t ) = A ( x , \frac{t}{α} ) in Ω \times ( 0 , \frac{T}{α} ) , Ω ⊆ {R}^{3} , T > 0 , α > 0 \qquad ( Eq . 13 )$$

For the changed electrical conductivity σ of the material, \tilde{σ}=ασ, the induced voltage in the receiver, following the quasi-stationary eddy current equation, the induced voltage is:

$$\begin{matrix}{\tilde{v}}_{RX} ( t ) = - {\partial }_{t} {∮}_{{Γ}_{RX}} \tilde{A} ( x , t ) \cdot dl \\ = - {\partial }_{t} {∮}_{{Γ}_{RX}} A ( x , \frac{t}{α} ) \cdot dl \\ = \frac{1}{α} {v}_{RX} ( \frac{t}{α} )\end{matrix} \qquad ( Eq . 14 )$$

The excitation current corresponding to the step response is:

$${\tilde{ι}}_{TX} ( t ) = {i}_{TX} ( \frac{t}{α} ) \qquad ( Eq . 15 )$$

The generated time-domain waveform in this case is:

$$\begin{matrix}\tilde{h} ( t ) = t \cdot {v}_{RX} ( t ) for {\tilde{ι}}_{TX} ( t ) \\ = \frac{t}{α} \cdot {v}_{RX} ( \frac{t}{α} ) for {i}_{TX} ( \frac{t}{α} ) \\ = h ( \frac{t}{α} )\end{matrix} \qquad ( Eq . 16 )$$

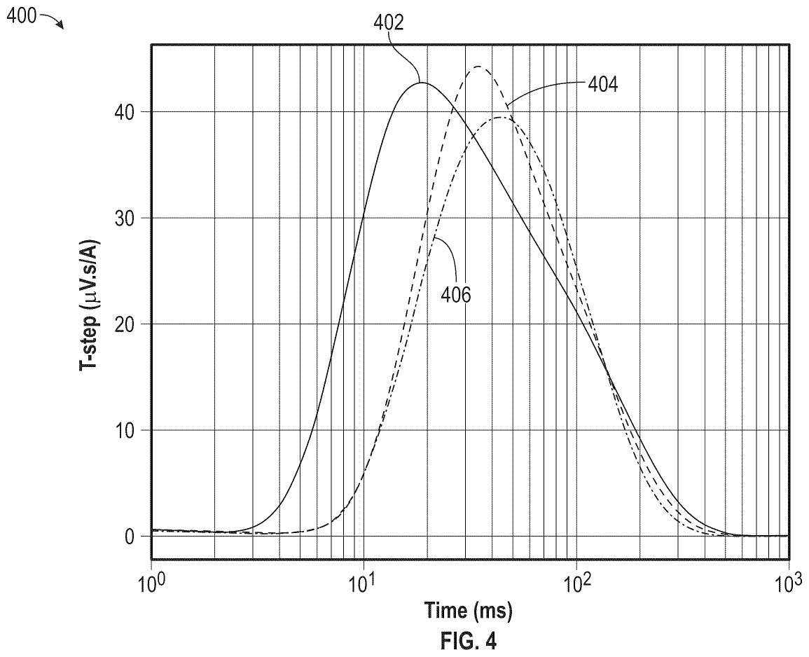

As shown in the above Eqs. 9-16, the generated time-domain waveforms corresponding to different electrical conductivities of the material are translated versions of each other on the logarithmic time axis and the shape of h(t) is unchanged in response to a change in electrical conductivity. FIG. 4 depicts the step response (t-step) waveforms 402, 404, 406.

Accordingly, the eddy current system excites a transmitter (TX) with multi-sine, chirp, or pulse-like signals and receives a response at one or more receivers (RX). The eddy current system estimates a frequency domain transfer function Z(s) (e.g., Eq. 5) of the coupling between the transmitter TX and receiver RX. The eddy current system may compute a time-domain waveform w(t) response signal by applying an inverse Laplace transform to

$$( - \frac{d}{ds} \frac{Z ( s )}{s} )$$

or equivalently by multiplying time by the step response of the transfer function (e.g., Eqs. 6-9). The eddy current system may perform digital signal processing (e.g., signal decomposition, inversion, machine learning, etc.) using as input the generated waveform w(t) to estimate parameters of interest (e.g., electrical conductivity, magnetic permeability and geometry) of a tested material, the parameters influencing the coupling between the TX and RX.

### Example Display of Eddy Current Response of Nested Pipes

As discussed herein, conventional eddy current response techniques may provide a raw output waveform displayed as wiggles, which is not easily interpretable even qualitatively. Moreover, in a nested pipe configuration, when thickness variations occur simultaneously on the different nested pipes, the individual thicknesses cannot be correctly identified because the time signature on the response waveforms will overlap.

Accordingly, the present disclosure provides techniques for outputting eddy current response data that can be easily qualitatively used to distinguish the nested pipes and to identify thickness variations in individual pipes of a nested pipe configuration. In some aspects, the qualitative analysis can be performed to evaluate corrosion of the pipes.

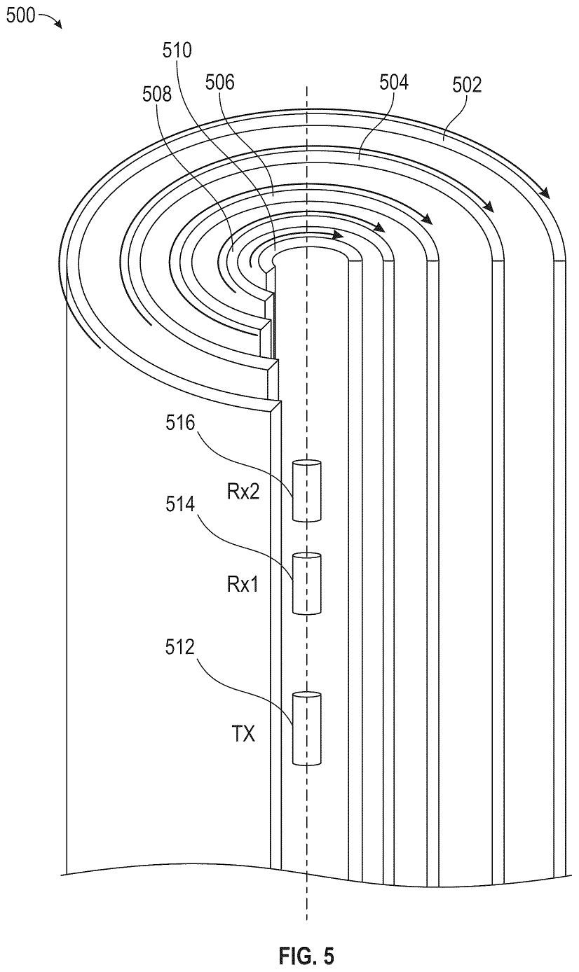

FIG. 5 depicts an example nested pipe configuration 500. As shown, the nested pipe configuration 500 includes an outer pipe 502, an inner pipe 510, and three concentric pipes 504, 506, and 508 between the outer pipe 502 and the inner pipe 510. In the example shown in FIG. 5, the system includes a transmitter coil (TX 512) and two receiver coils (RX 514 and RX 516) within the nested pipe configuration. The two receiver coils are spaced at different distances from the transmitter coil, providing for different penetration depths of the investigation.

The transmitter coil may excite multiple frequencies and covers a large bandwidth (e.g., from a fraction of Hz and up to almost a kHz). From the voltages measured at each receiver coil, the frequency-domain transfer function of the transmitter-receiver coupling is estimated. A time-domain representation can be computed from the transfer function. For example, the time-domain representation may be computed in the Laplace domain or in the Fourier domain. In some aspects, the time-domain representation can be computed as discussed above with respect to the Eq. 9.

According to certain aspects, the time domain data is displayed for qualitative analysis without a reference waveform. In some aspects, the time domain data is displayed as a colored image.

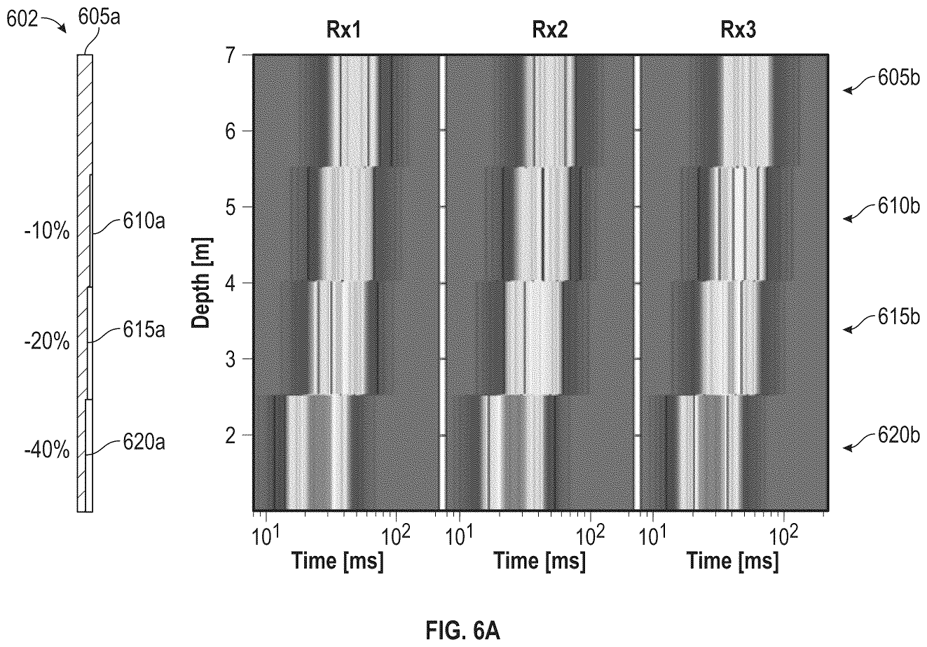

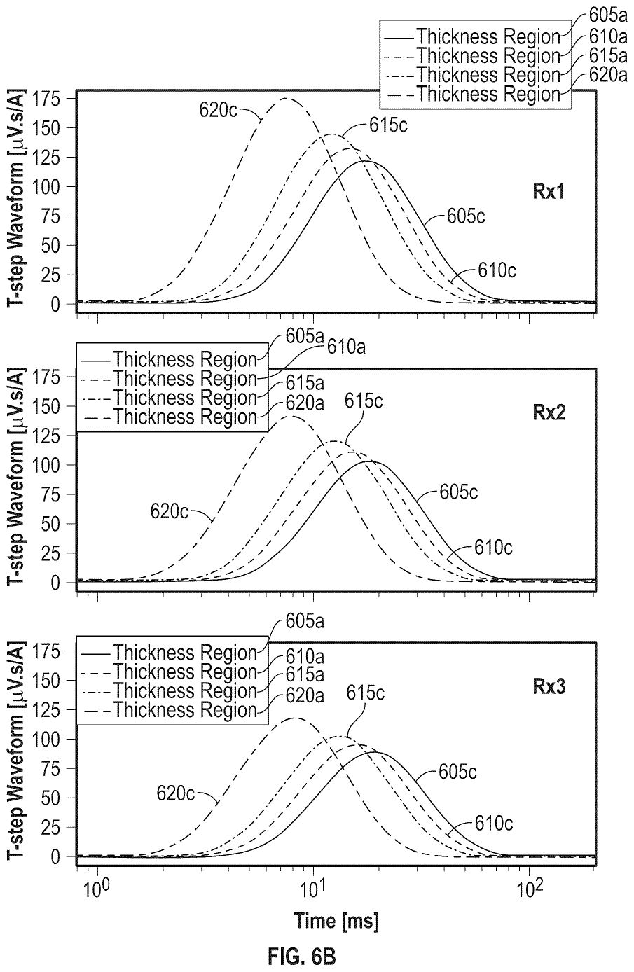

FIG. 6A illustrates an example display of simulated logs of time-domain eddy current data for a single casing at various transmitter-receiver spacings, according to one or more aspects. FIG. 6A illustrates a casing 602 with four different regions of progressively reduced thickness, 605a, 610a (−10% thickness), 615a (−20% thickness), and 620a (−40% thickness) at various depths, respectively. FIG. 6A illustrates the simulated responses 605b, 610b, 615b, and 620b, respectively, for each of the four different regions of the casing 602, at three different transmitter-receiver spacings, Rx1, Rx2, and Rx3. FIG. 6B illustrates a display of the time-indexed waveforms 605c, 610c, 615c, and 620c for each of the four different regions 605a, 610a, 615a, and 620a, respectively, at each of the three transmitter-receiver spacings Rx1, Rx2, and Rx3. As shown, the display of the time-indexed waveforms may be the t-step waveforms (e.g., similar to FIG. 4).

As shown in FIGS. 6A-6B, each of the three transmitter-receiver spacings respond differently, however, in each of the three transmitter-receiver spacings the respective response waveform shifts in the direction of the early time indexes as the thickness of the casing 602 is reduced. In addition, in each of the three transmitter-receiver spacings, the peak of the response waveform increases as the thickness of the casing 602 is reduced. Thus, a detected shift in the response waveform to earlier time indexes and/or an increase in the peak of the response waveform indicates a change in the thickness of the casing, for example, due to thinning, corrosion, or other factors. Accordingly, the time-indexed display of the eddy current response provides an easy approach for an operator to qualitatively spot areas of the casing in need of maintenance or repair.

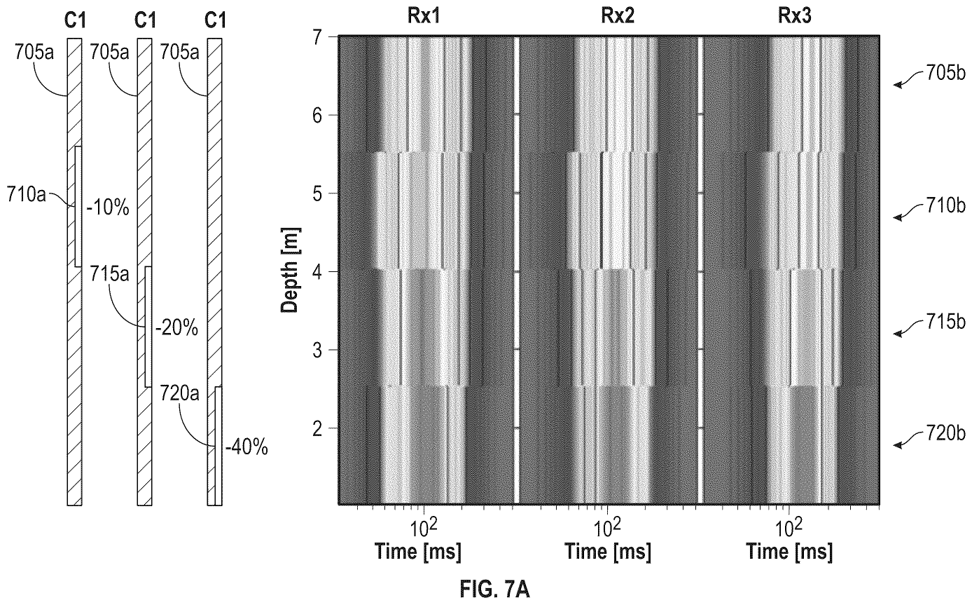

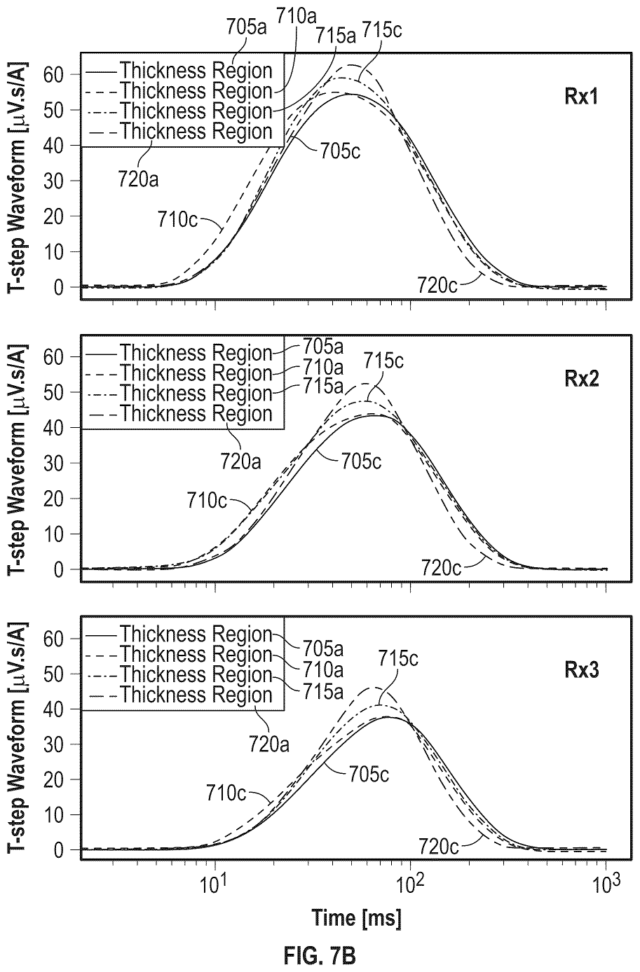

FIGS. 7A-7B illustrates an example display of simulated logs of time-domain eddy current data for three nested casings, C1, C2, C3, respectively, at the transmitter-receiver spacings Rx1, Rx2, Rx3, at various depths, according to one or more aspects. In the example depicted in FIGS. 7A-7B, the casings includes regions of no corrosion, or full thickness 705a, while the casing C1 includes a region of reduced thickness 710a (−10% thickness), the casing C2 includes a region of reduced thickness 715a (−20% thickness), and the casing C3 includes a region of reduced thickness 720a (−40% thickness) with simulated responses 705b, 710b, 715b, and 720b, and simulated time-index waveforms 705c, 710c, 715c, and 720c.

As shown, the corrosion in the region of reduced thickness 710a of the inner casing C1 is visible from the shift to the earlier time-indices and increase in the peak value are apparent in the earlier times. However, for the outer casings C2 and C3, the shifts in the corrosion regions 715a and 720a are less apparent in earlier times, but appear on the later times. An increase or decrease in thickness of a casing will appear as a shift in time in the response waveform to earlier or later time indexes, respectively. Additionally or alternatively, the increase or decrease in the thickness of the casing will appear an increase or decrease, respectively, in the peak amplitude of the response waveform. Thus, such a change occurring at early times indicates a change in the thickness of the inner casing while the change occurring at later times indicates a change in the thickness of an outer casing.

Accordingly, an eddy current system may operate an eddy current well logging tool including a transmitter coil and at least one receiver coil in a borehole equipped with one or more pipes in a nested configuration. The eddy current system may transmit an excitation current at a set of multiple selected frequencies from the transmitter coil and measure response voltages at the one or more receiver coil(s). The eddy current system may process the measured frequency domain data to generate a time domain representation of the response. The eddy current system may display the time-indexed data as an image.

Example Method for Well Integrity Evaluation with Eddy Currents

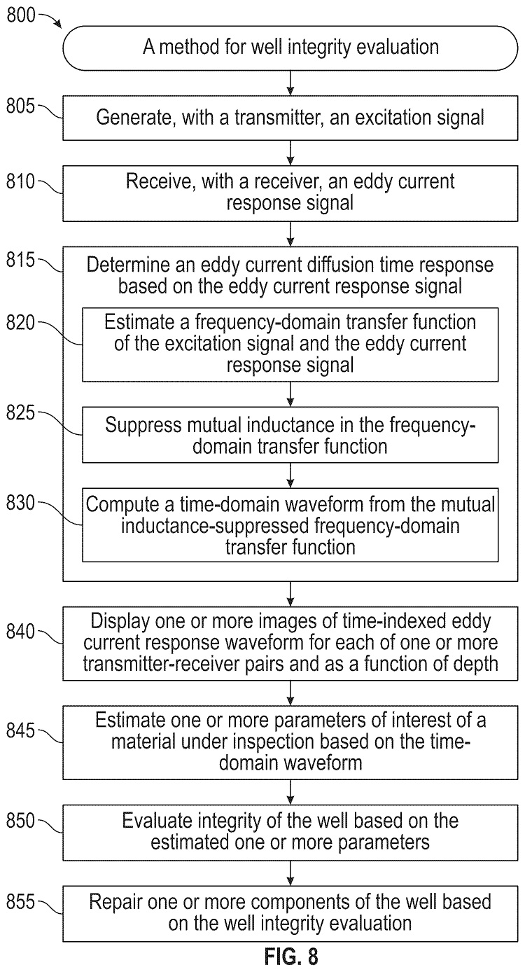

FIG. 8 depicts example operations 800 for well integrity evaluation with eddy current diffusion time response. In some aspects, the well includes a nested pipe configuration.

The operations 800 may begin, at operation 805, with a transmitter generating an excitation signal. In some aspects, the excitation signal is a multi-sine, chirp, step current, or pulse signal. In some aspects, the transmitter is a driver coil. In some aspects, the transmitter excites multiple frequencies over large bandwidth. In some aspects, the transmitter excited broadband frequencies.

The operations 800 may continue, at operation 810, with a receiver receiving an eddy current response signal. In some aspects, the receiver is a pick-up coil. In some aspects, the receiver measures response voltages. In some aspects, multiple receivers are used with multiple transmitter-receiver spacings.

In some aspects, the receiver measures frequency-domain response voltages and the system generates a time-domain representation of the frequency-domain data. In some aspects, the time-domain representation of the data is time indexed.

The operations 800 may include, at operation 815, determining an eddy current diffusion time response based on the eddy current response signal.

Determining the eddy current diffusion time response at operation 815 may include, at operation 820, estimating a frequency-domain transfer function Z(s) (e.g., according to the Eq. 2) of the coupling between the transmitter and receiver.

Determining the eddy current diffusion time response at operation 815 may include, at operation 825, suppressing mutual inductance in the transfer function. In some aspects, the mutual inductance is suppressed by dividing the transfer function by a complex frequency variable (e.g., s) and taking a derivation with respect of s of the remainder (e.g., according to the Eq. 6).

Determining the eddy current diffusion time response at operation 815 may include, at operation 830, computing a time-domain waveform w(t) by applying by multiplying time by the step response of the transfer function (e.g., according to the Eqs. 8-9). The time-domain waveform w(t) removes the disturbance of inductive direct coupling of the transfer function. Further, the shape of the time-domain waveform w(t) is independent of electrical conductivity of the material under inspection.

The operations 800 may include, at operation 835, displaying the time-domain waveform. In some aspects, one or more images of time-domain indexed data displays a color corresponding to the response magnitude for each of one or more transmitter-receiver pairs and as a function of time and depth (e.g., as shown in FIGS. 6A-7B).

The operations 800 may include, at operation 840, estimating one or more parameters of interest of a material under inspection based on the generated time-domain waveform. In some aspects, digital processing is performed using the time-domain waveform as input. The digital processing may include signal decomposition, inversion, machine learning, or other digital processing. The parameters of interest may include electrical conductivity, magnetic permeability, and/or geometry of the material under inspection. In some aspects, one or more parameters of interest are estimated based on the one or more displayed images.

The operations 800 may include, at operation 845, evaluating integrity of the well based on the one or more parameters of interest. In some aspects, evaluating the integrity of the well includes identifying (e.g., and/or quantifying) cracks, corrosion, fatigue, pitting, erosion, thinning, wear, defects in one or more components of the well (e.g., pipe, coatings, welds, tubing, casing, drilling equipment, etc.). In some aspects, evaluating the well integrity includes identifying corrosion of a pipe of a nested pipe configuration based on identifying, using a displayed image, a shift in the response waveform to earlier time indexes, a shift of the response waveform increasing in amplitude, a time region of where the shift occurs, and/or a transmitter-receiver spacing at which the shift occurs.

The operations 800 may include, at operation 850, repairing one or more components of the well based on the well integrity evaluation.

Example System for Well Integrity Evaluation with Eddy Currents

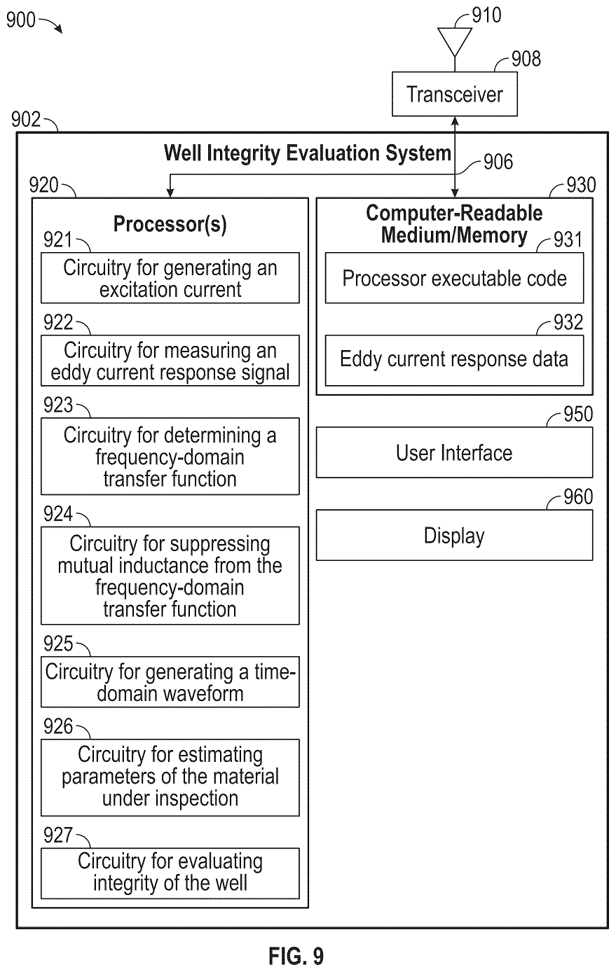

FIG. 9 depicts aspects of an example well integrity evaluation system 900. Well integrity evaluation system 900 may be implemented as a single device or, in some aspects, components of well integrity evaluation system 900 may be implemented across multiple physical devices. In some aspects, the components of well integrity evaluation system 900 may be located at the well, remotely from the well, and/or distributed across locations at the well and remote locations.

The well integrity evaluation system 900 includes a processing system 902, which may be coupled to a transceiver 908 (e.g., a transmitter and/or a receiver). The transceiver 908 may be configured to transmit and receive signals for the well integrity evaluation system 900 wirelessly via an antenna 910 or over a wired connection. The transceiver may be used for inter-communication between components within the well integrity evaluation system 900 and/or for communication with other devices or systems over a network.

The processing system 902 includes one or more processors 920. The one or more processors 920 may be coupled to a computer-readable medium/memory 930 via a bus 906 or may communicate with the computer-readable medium/memory 930 via a wired or wireless connection over a network. In certain aspects, the computer-readable medium/memory 930 is configured to store instructions (e.g., computer-executable code 731) that when executed by the one or more processors 920, cause the one or more processors 920 to perform the operations 800 described with respect to FIG. 8, or any aspect related to it. Note that reference to a processor performing a function of system 900 may include one or more processors performing that function of system 900.

The one or more processors 920 include circuitry configured to implement (e.g., execute) the aspects described herein for well integrity evaluation, including circuitry for generating an excitation current 921, circuitry for measuring an eddy current response signal 922, circuitry for determining a frequency-domain transfer function 923, circuitry for suppressing mutual inductance from the frequency-domain transfer function 924, circuitry for generating a time-domain waveform 925, circuitry for estimating parameters of the material under inspection 926, and circuitry for evaluating integrity of the well 927. Processing with circuitry 921-927 may cause the well integrity evaluation system 900 to perform the operations 800 described with respect to FIG. 8 or any aspect related to it.

Computer-readable medium/memory 930 may store information that can be used by the processors 920. For example, computer-readable medium/memory 930 may store an eddy current response data 932 measured by one or more receivers.

The well integrity evaluation system 900 may include a user interface 950 to accept inputs from a user. In some aspects, the user interface 950 is a graphical user interface (GUI). In some aspects, the GUI accepts touch screen inputs from the user. In some aspects, the user interface 950 includes one or more input/output (IOs) interfaces that allows one or more I/O devices (e.g., keyboards, displays, mouse devices, pen inputs, microphones, etc.) to connect to the well integrity evaluation system 900. The inputs from the user may include decisions on the repairing components of the well.

The well integrity evaluation system 900 may include a display 960 configured to display visualizations of the eddy current response data discussed herein, such as the images of the time-indexed eddy current response for transmitter-receiver pairs as a function of depth.

### EXAMPLE CLAUSES

Implementation examples are described in the following numbered clauses:
Clause 1: A system for eddy current logging in a well, the system comprising: one or more transmitter coils in the well configured to generate an excitation current; one or more receiver coils in the well configured to measure an eddy current response signal, wherein the eddy current response signal comprises a voltage response; and one or more processors configured to: determine a frequency-domain transfer function based on a ratio of the voltage response to the excitation current; suppress mutual inductance from the frequency-domain transfer function; and generate a time-domain waveform based on the mutual inductance suppressed frequency-domain transfer function.
Clause 2: The system of Clause 1, wherein the transmitter is configured to generate a multi-sine, chirp, step current, or pulse excitation signal.
Clause 3: The system of any combination of Clauses 1-2, wherein the one or more processors are configured to determine the frequency-domain transfer function by determining the ratio of a Laplace transform of the voltage response to the Laplace transform of the excitation current.
Clause 4: The system of Clause 3, wherein the one or more processors are configured to suppress the mutual inductance from the frequency-domain transfer function by: normalizing the frequency-domain transfer function with respect to a complex frequency variable; and determining a derivative of the normalized frequency-domain transfer function with respect to the complex frequency variable.
Clause 5: The system of Clause 4, wherein the one or more processors are configured to generate the time-domain waveform by determining a product of time and a step response of the mutual inductance suppressed frequency-domain transfer function.
Clause 6: The system of any combination of Clauses 4-5, wherein the one or more processors are configured to generate the time-domain waveform by applying an inverse Laplace transform to the mutual inductance suppressed frequency-domain transfer function.
Clause 7: The system of any combination of Clauses 1-6, wherein the one or more processors are configured to estimate one or more parameters of interest of a material under inspection based on the generated time-domain waveform, the one or more parameters of interest including at least one of electrical conductivity, magnetic permeability, or geometry of the material under inspection.
Clause 8: The system of Clause 7, further comprising a display configured to display the estimated one or more parameters of interest of the material under inspection.
Clause 9: The system of any combination of Clauses 7-8, wherein: the one or more processors are configured to evaluate integrity of the well based on the estimated one or more parameters of interests of the material under inspection by identifying at least one of: cracks, corrosion, fatigue, pitting, erosion, thinning, wear, or defects in one or more components of the well; and the one or more components of the well comprise at least one of: one or more pipes, one or more coatings, one or more welds, one or more tubings, one or more casings, or one or more drilling equipment.
Clause 10: The system of Clause 9, further comprising a configured to display the evaluation of the integrity of the well.
Clause 11: The system of any combination of Clauses 1-10, further comprising a display configured to display the time-domain waveform.
Clause 12: The system of any combination of Clauses 1-11, further comprising a display configured to display an image of a magnitude of the current eddy response represented by a color or intensity as a function of time and depth.
Clause 13: The system of Clause 12, wherein: the one or more receiver coils comprises multiple receiver coils at multiple distances from the transmitter; and the display is configured to display, for each of the multiple receiver coils, the magnitude of the current eddy response represented by the color or intensity as a function of time and depth.
Clause 14: A method for well integrity evaluation, the method comprising: generating, via one or more transmitter coils in the well, an excitation current; measuring, via one or more receiver coils in the well, an eddy current response signal, wherein the eddy current response signal comprises a voltage response; determining, via one or more processors, a frequency-domain transfer function based on a ratio of the voltage response to the excitation current; suppressing, via the one or more processors, mutual inductance from the frequency-domain transfer function; generating, via the one or more processors, a time-domain waveform based on the mutual inductance suppressed frequency-domain transfer function; estimating one or more parameters of a material under inspection based on the time-domain waveform; and evaluating integrity of the well based on the estimated one or more parameters of the material under inspection.
Clause 15: The method of Clause 14, further comprising, based on the evaluation of the integrity of the well, at least one of: initiating inspection or repairs of one or more components of the well; or adjusting one or more drilling parameters of the well.
Clause 16: The method of any combination of Clauses 14-15, further comprising displaying information associated with the time-domain waveform.
Clause 17: The method of Clause 16, wherein: the information associated with the time-domain waveform comprises an image of a magnitude of the current eddy response represented by a color or intensity as a function of time and depth; and estimating the one or more parameters of the material under inspection based on the time-domain waveform comprises: identifying a change in thickness of at least one pipe in the well based on at least one of: a shift in the eddy current response to earlier times or an increase in a peak of the eddy current response; and identifying a depth at which the change in thickness occurs.
Clause 18: The method of Clause 17, wherein: the well includes a nested pipe configuration comprising a plurality of concentric pipes; and identifying the change in thickness of the at least one pipe further comprises identifying the pipe associated with the change in thickness further based on a time at which the shift in the eddy current response occurs, a time at which the increase in the peak occurs, or a receiver coil that measured the eddy current response.
Clause 19: The method of any combination of Clauses 17-18, wherein evaluating the integrity of the well based on the estimated one or more parameters of the material under inspection comprises determining corrosion of the at least one pipe in response to identifying the change in thickness of the at least one pipe.
Clause 20: The method of any combination of Clauses 14-19, wherein: determining the frequency-domain transfer function comprises determining the ratio of the Laplace transform of the voltage response to the Laplace transform of the excitation current; and suppressing the mutual inductance from the frequency-domain transfer function comprises: normalizing the frequency-domain transfer function with respect to a complex frequency variable; and determining a derivative of the normalized frequency-domain transfer function with respect to the complex frequency variable.
Clause 21: The method of Clause 20, wherein generating the time-domain waveform comprises: determining a product of time and a step response of the mutual inductance suppressed frequency-domain transfer function; or applying an inverse Laplace transform to the mutual inductance suppressed frequency-domain transfer function.
Clause 22: A method for operating the system in accordance with any of Clauses 1-13.
Clause 23: A computer-readable medium comprising executable instructions that, when executed by one or more processors of an apparatus, cause the apparatus to operate the system in accordance with any of Clauses 1-13.
Clause 24: An apparatus comprising: a memory comprising executable instructions and one or more processors configured to execute the executable instructions and cause the apparatus to operate the system in accordance with any of Clauses 1-13.
Clause 25: An apparatus comprising means for operating the system in accordance with any of Clauses 1-13.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of aspects discussed without departing from the scope of the disclosure. Various examples may omit, substitute, or add various procedures or aspects as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A system for eddy current logging in a well, the system comprising:
one or more transmitter coils in the well configured to generate an excitation current;
one or more receiver coils in the well configured to measure an eddy current response signal, wherein the eddy current response signal comprises a voltage response; and
one or more processors configured to:
determine a frequency-domain transfer function based on a ratio of the voltage response to the excitation current;
suppress mutual inductance from the frequency-domain transfer function; and
generate a time-domain waveform based on the mutual inductance suppressed frequency-domain transfer function.

2. The system of claim 1, wherein the one or more transmitter coils are configured to generate a multi-sine, chirp, step current, or pulse excitation signal.

3. The system of claim 1, wherein the one or more processors are configured to determine the frequency-domain transfer function by determining the ratio of a Laplace transform of the voltage response to the Laplace transform of the excitation current.

4. The system of claim 3, wherein the one or more processors are configured to suppress the mutual inductance from the frequency-domain transfer function by:
normalizing the frequency-domain transfer function with respect to a complex frequency variable; and
determining a derivative of the normalized frequency-domain transfer function with respect to the complex frequency variable.

5. The system of claim 4, wherein the one or more processors are configured to generate the time-domain waveform by determining a product of time and a step response of the mutual inductance suppressed frequency-domain transfer function.

6. The system of claim 4, wherein the one or more processors are configured to generate the time-domain waveform by applying an inverse Laplace transform to the mutual inductance suppressed frequency-domain transfer function.

7. The system of claim 1, wherein the one or more processors are configured to estimate one or more parameters of interest of a material under inspection based on the generated time-domain waveform, the one or more parameters of interest including at least one of electrical conductivity, magnetic permeability, or geometry of the material under inspection.

8. The system of claim 7, further comprising a display configured to display the estimated one or more parameters of interest of the material under inspection.

9. The system of claim 7, wherein:
the one or more processors are configured to evaluate integrity of the well based on the estimated one or more parameters of interests of the material under inspection by identifying at least one of: cracks, corrosion, fatigue, pitting, erosion, thinning, wear, or defects in one or more components of the well; and
the one or more components of the well comprise at least one of: one or more pipes, one or more coatings, one or more welds, one or more tubings, one or more casings, or one or more drilling equipment.

10. The system of claim 9, further comprising a display configured to display the evaluation of the integrity of the well.

11. The system of claim 1, further comprising a display configured to display the time-domain waveform.

12. The system of claim 1, further comprising a display configured to display an image of a magnitude of the current eddy response represented by a color or intensity as a function of time and depth.

13. The system of claim 12, wherein:
the one or more receiver coils comprises multiple receiver coils at multiple distances from the one or more transmitter coils; and
the display is configured to display, for each of the multiple receiver coils, the magnitude of the current eddy response represented by the color or intensity as a function of time and depth.

14. A method for well integrity evaluation, the method comprising:
generating, via one or more transmitter coils in the well, an excitation current;
measuring, via one or more receiver coils in the well, an eddy current response signal, wherein the eddy current response signal comprises a voltage response;
determining, via one or more processors, a frequency-domain transfer function based on a ratio of the voltage response to the excitation current;
suppressing, via the one or more processors, mutual inductance from the frequency-domain transfer function;
generating, via the one or more processors, a time-domain waveform based on the mutual inductance suppressed frequency-domain transfer function;
estimating one or more parameters of a material under inspection based on the time-domain waveform; and
evaluating integrity of the well based on the estimated one or more parameters of the material under inspection.

15. The method of claim 14, further comprising, based on the evaluation of the integrity of the well, at least one of:
initiating inspection or repairs of one or more components of the well; or
adjusting one or more drilling parameters of the well.

16. The method of claim 14, further comprising displaying information associated with the time-domain waveform.

17. The method of claim 16, wherein:
the information associated with the time-domain waveform comprises an image of a magnitude of the eddy current response signal represented by a color or intensity as a function of time and depth; and
estimating the one or more parameters of the material under inspection based on the time-domain waveform comprises:
identifying a change in thickness of at least one pipe in the well based on at least one of: a shift in the eddy current response signal to earlier times or an increase in a peak of the eddy current response signal; and
identifying a depth at which the change in thickness occurs.

18. The method of claim 17, wherein:
the well includes a nested pipe configuration comprising a plurality of concentric pipes; and
identifying the change in thickness of the at least one pipe further comprises identifying the pipe associated with the change in thickness further based on a time at which the shift in the eddy current response occurs, a time at which the increase in the peak occurs, or a receiver coil that measured the eddy current response.

19. The method of claim 17, wherein evaluating the integrity of the well based on the estimated one or more parameters of the material under inspection comprises determining corrosion of the at least one pipe in response to identifying the change in thickness of the at least one pipe.

20. A non-transitory computer readable medium comprising computer executable code for eddy current logging in a well, the computer executable code comprising:
code for determining a frequency-domain transfer function based on a ratio of an eddy current voltage response signal to an excitation current;
code for suppressing mutual inductance from the frequency-domain transfer function;
code for generating a time-domain waveform based on the mutual inductance suppressed frequency-domain transfer function; and
code for outputting information associated with the time-domain waveform.
